(19) United States
(12) Patent Application Publication
(10) Pub. No.: US 2024/0135336 A1
(43) Pub. Date: Apr. 25, 2024

(54) QUOTE DISPLAY METHOD AND APPARATUS FOR FAULTY AUTOMOBILE ACCESSORY, AND ELECTRONIC DEVICE

(71) Applicant: Autel Intelligent Technology Corp., Ltd., Shenzhen (CN)

(72) Inventors: Fusheng XIE, Shenzhen (CN); Bin ZHANG, Shenzhen (CN)

(73) Assignee: Autel Intelligent Technology Corp., Ltd., Shenzhen, GD (CN)

(21) Appl. No.: 18/277,778

(22) PCT Filed: Dec. 13, 2021
(86) PCT No.: PCT/CN2021/137482

§ 371 Date: Aug. 17, 2023

(30) Foreign Application Priority Data
Feb. 24, 2021 (CN) 202110206672.8

(51) Int. Cl. G06Q 10/20

(52) U.S. Cl. CPC G06Q 10/20

(57) ABSTRACT

A quote display method includes: the automobile repair terminal sending a parameter test value of the automobile accessory to the test server; the test server sending the parameter test value to the big data platform; the big data platform determining a target keyword corresponding to a faulty automobile accessory according to the parameter test value and a parameter standard value of the automobile accessory, and sending the target keyword corresponding to the faulty automobile accessory to the test server: the test server sending the target keyword to the automobile repair terminal; the automobile repair terminal sending the target keyword to the quote server: the quote server determining, according to the target keyword, accessory information and accessory quote of a target automobile accessory, sending the accessory information and the accessory quote to the automobile repair terminal; the automobile repair terminal displaying the accessory information and the accessory quote.

### BACKGROUND

### Cross Reference

The present application claims priority to the Chinese patent application No. 202110206672.8 entitled “quote display method and apparatus for faulty automobile accessory, and electronic device” filed on Feb. 24, 2021 to the China National Intellectual Property Administration, the entire contents of which are incorporated herein by reference.

### TECHNICAL FIELD

The present application relates to the technical field of automobile repair, in particular to a quote display method and apparatus for a faulty automobile accessory, and an electronic device.

### RELATED ART

An automobile repair software is an application software to assist automobile repairing personnel in performing automobile repair. With the development of technologies, the function of automobile repair software is more and more abundant.

In an automobile repair scenario, an automobile repairman measures a parameter value of an automobile accessory through a professional test device, and inputs the parameter value of the automobile accessory into the automobile repair software such that the automobile repair software automatically analyzes whether the automobile accessory is damaged, and displays an analysis result to the automobile repair personnel. Based on the analysis result, the automobile repairman further looks for a quote for the automobile accessory that can replace the faulty automobile accessory. However, in implementing the present invention, the inventors have found that: in the related art, the automobile repairman needs to manually look for the quote for the automobile accessory, which is inefficient.

### SUMMARY

In view of the above problems, the embodiments of the present invention provide a quote display method and apparatus for a faulty automobile accessory, and an electronic device for solving the problem of low efficiency in the quote search of an automobile accessory in the prior art.

According to an aspect of an embodiment of the present invention, there is provided a quote display method for a faulty automobile accessory, which is applied to a quote display system for a faulty automobile accessory. The quote display system for a faulty automobile accessory comprises an automobile repair terminal for interacting with a user and displaying data, a test server for sending a parameter test value, a big data platform for determining a faulty automobile accessory, and a quote server for determining accessory information and accessory quote.

The method includes steps as follows:
the automobile repair terminal acquires a parameter test value of an automobile accessory, and sends the parameter test value of the automobile accessory to a test server;
the test server sends the parameter test value to the big data platform;
the big data platform determines a target keyword corresponding to a faulty automobile accessory according to the parameter test value and a parameter standard value of the automobile accessory, and sends the target keyword corresponding to the faulty automobile accessory to the test server;
the test server receives the target keyword, and sends the target keyword to the automobile repair terminal;
the automobile repair terminal receives the target keyword, and sends the target keyword to the quote server;
the quote server receives the target keyword, determines, according to the target keyword, accessory information and accessory quote of a target automobile accessory, and sends the accessory information and the accessory quote to the automobile repair terminal, the target automobile accessory being an automobile accessory for replacing the faulty automobile accessory;
the automobile repair terminal displays the accessory information and the accessory quote.

In an alternative mode, the big data platform pre-stores a first correspondence of an automobile accessory and a corresponding keyword;
the big data platform determining a target keyword corresponding to a faulty automobile accessory according to the parameter test value and a parameter standard value of the automobile accessory comprises:
the big data platform determining a faulty automobile accessory according to the parameter test value and the parameter standard value of the automobile accessory; and
the big data platform determining the target keyword according to the faulty automobile accessory and the first correspondence.

In an alternative mode, the quote server pre-stores a keyword and the second correspondence of the corresponding accessory information and accessory quote;
the quote server receiving the target keyword, and determining, according to the target keyword, accessory information and accessory quote of a target automobile accessory comprises:
the quote server receiving the target keyword, and determining accessory information about and accessory quote of the target automobile accessory according to the target keyword and the second correspondence.

In an alternative mode, the automobile repair terminal communicates with the quote server through an HTTP protocol;
the automobile repair terminal receiving the target keyword, and sending the target keyword to the quote server comprises:
the automobile repair terminal receiving the target keyword, and importing the target keyword into a parameter of an accessory inquiry and quote interface of the quote server via the HTTP protocol.

In an alternative mode, the automobile repair terminal communicates with the quote server via a message queue;
the automobile repair terminal receiving the target keyword, and sending the target keyword to the quote server comprises:
the automobile repair terminal receiving the target keyword, and importing the target keyword into a parameter of an accessory inquiry and quote interface of the quote server via a message queue.

In an alternative mode, the big data platform determining a target keyword corresponding to a faulty automobile accessory according to the parameter test value and a parameter standard value of the automobile accessory comprises:
the big data platform determining a parameter standard value corresponding to each parameter test value in multiple parameter test values according to the multiple parameter test values of the automobile accessory; and
if a difference value between any parameter test value and a corresponding parameter standard value is outside a preset threshold range, then the automobile accessory being determined as the faulty automobile accessory and a keyword corresponding to the automobile accessory being determined as the target keyword.

According to another aspect of the embodiments of the present invention, there is provided a quote display method for a faulty automobile accessory, being applied to an automobile repair terminal for a quote display system of a faulty automobile accessory, wherein the quote display system for a faulty automobile accessory comprises an automobile repair terminal for interacting with a user and displaying data, a test server for sending a parameter test value, a big data platform for determining a faulty automobile accessory, and a quote server for determining accessory information and accessory quote;
the method includes:
acquiring the parameter test value of an automobile accessory, and sending the parameter test value of the automobile accessory to the test server for the test server to send the parameter test value to the big data platform, the big data platform determining a target keyword corresponding to a faulty automobile accessory according to the parameter test value and a parameter standard value of the automobile accessory and sending the target keyword corresponding to the faulty automobile accessory to the test server, and the test server receiving the target keyword;
receiving the target keyword sent by the test server, and sending the target keyword to the quote server for the quote server to determine the accessory information about and the accessory quote of the target automobile accessory according to the target keyword;
receiving the accessory information and accessory quote sent by the quote server;
and displaying the accessory information and accessory quote.

In an alternative mode, the automobile repair terminal communicates with the quote server through an HTTP protocol;
the sending the target keyword to the quote server comprises:
sending the target keyword to the quote server through the HTTP protocol.

In an alternative mode, the automobile repair terminal communicates with the quote server via a message queue;
the sending the target keyword to the quote server comprises:
sending the target keyword to the quote server via the message queue.

According to another aspect of the embodiments of the present invention, there is provided a quote display apparatus for a faulty automobile accessory, being applied to an automobile repair terminal for a quote display system of a faulty automobile accessory, wherein the quote display system for a faulty automobile accessory comprises an automobile repair terminal for interacting with a user and displaying data, a test server for sending a parameter test value, a big data platform for determining a faulty automobile accessory, and a quote server for determining accessory information and accessory quote;
the apparatus comprises:
a first sending module for acquiring the parameter test value of an automobile accessory, and sending the parameter test value of the automobile accessory to the test server for the test server to send the parameter test value to the big data platform, the big data platform determining a target keyword corresponding to a faulty automobile accessory according to the parameter test value and a parameter standard value of the automobile accessory and sending the target keyword corresponding to the faulty automobile accessory to the test server, and the test server receiving the target keyword;
a second sending module for receiving the target keyword sent by the test server, and sending the target keyword to the quote server for the quote server to determine the accessory information about and the accessory quote of a target automobile accessory according to the target keyword;
a receiving module for receiving the accessory information and accessory quote sent by the quote server; and
a display module for displaying the accessory information and accessory quote.

According to another aspect of the embodiments of the present invention, there is provided an electronic device, comprising: a processor, a memory, a communication interface, and a communication bus, wherein the processor, the memory, and the communication interface complete mutual communication through the communication bus;
the memory is used for storing at least one executable instruction that causes the processor to execute an operation of the quote display method for a faulty automobile accessory as mentioned above.

According to another aspect of the embodiments of the present invention, there is provided a computer-readable storage medium, wherein at least one executable instruction is stored in the storage medium, and when the executable instruction runs on an electronic device, the executable instruction causes the electronic device to execute an operation of the quote display method for a faulty automobile accessory as mentioned above.

According to another aspect of the embodiments of the present invention, there is provided a quote display system for a faulty automobile accessory, characterized in that the system comprises an automobile repair terminal for interacting with a user and displaying data, a test server for sending a parameter test value, a big data platform for determining a faulty automobile accessory, and a quote server for determining accessory information and accessory quote;
the automobile repair terminal is used for acquiring the parameter test value of an automobile accessory, and sending the parameter test value of the automobile accessory to the test server;
the test server is used for sending the parameter test value to the big data platform;
the big data platform is used for determining a target keyword corresponding to a faulty automobile accessory according to the parameter test value and a parameter standard value of the automobile accessory, and sending the target keyword corresponding to the faulty automobile accessory to the test server;
the test server is used for receiving the target keyword, and sending the target keyword to the automobile repair terminal;
the automobile repair terminal is used for receiving the target keyword, and sending the target keyword to the quote server;
the quote server is used for receiving the target keyword, determining, according to the target keyword, the accessory information and the accessory quote of a target automobile accessory, and sending the accessory information and the accessory quote to the automobile repair terminal, the target automobile accessory being an automobile accessory for replacing the faulty automobile accessory;
the automobile repair terminal is further used for displaying the accessory information and the accessory quote.

The embodiment of the present invention acquires a parameter test value of an automobile accessory via an automobile repair terminal, a test server sends the parameter test value to a big data platform, and the big data platform determines a target keyword according to the parameter test value and a parameter standard value; the test server sends the target keyword to an automobile repair terminal; the automobile repair terminal sends the target keyword to the quote server; the quote server determines the accessory information and the accessory quote of a target automobile accessory according to the target keyword, and sends the accessory information and the accessory quote to the automobile repair terminal, so that the automobile repair terminal displays the accessory information and the accessory quote. Through the above-mentioned steps, after acquiring the parameter test value of the automobile accessory, the automobile repair terminal can determine the accessory information and accessory quote corresponding to the target automobile accessory for replacing the faulty automobile accessory according to the target keyword corresponding to the faulty automobile accessory, so as to display the accessory information and accessory quote of the target automobile accessory to the automobile repair personnel, which is conducive to quickly finding the accessory quote.

The above description is only an overview of the technical schemes of the embodiments of the invention. In order to understand the technical means of the embodiments of the invention more clearly, it can be implemented according to the contents of the description. In order to make the above and other purposes, features, and advantages of the embodiments of the invention more obvious and understandable, specific implementation modes of the invention are listed below.

### BRIEF DESCRIPTION OF THE DRAWINGS

The drawings are only for the purpose of illustrating the implementation modes and are not to be construed as limiting the present invention. Moreover, like reference numerals denote like components throughout the drawings. In the drawings:

FIG. 1 shows a schematic flow diagram of a quote display method for a faulty automobile accessory provided by an embodiment of the present invention;

FIG. 2 shows a schematic flow diagram of a quote display method for a faulty automobile accessory provided by another embodiment of the present invention;

FIG. 3 shows a schematic structural diagram of a quote display apparatus for a faulty automobile accessory provided by an embodiment of the present invention;

FIG. 4 shows a schematic structural diagram of an electronic device provided by an embodiment of the present invention;

FIG. 5 shows a schematic structural diagram of a quote display system for a faulty automobile accessory provided by an embodiment of the present invention.

### DETAILED DESCRIPTION

Hereinafter, exemplary embodiments of the present invention will be described in more detail with reference to the accompanying drawings. While the drawings show exemplary embodiments of the invention, it should be understood that the invention may be implemented in various forms and should not be limited by the embodiments described herein.

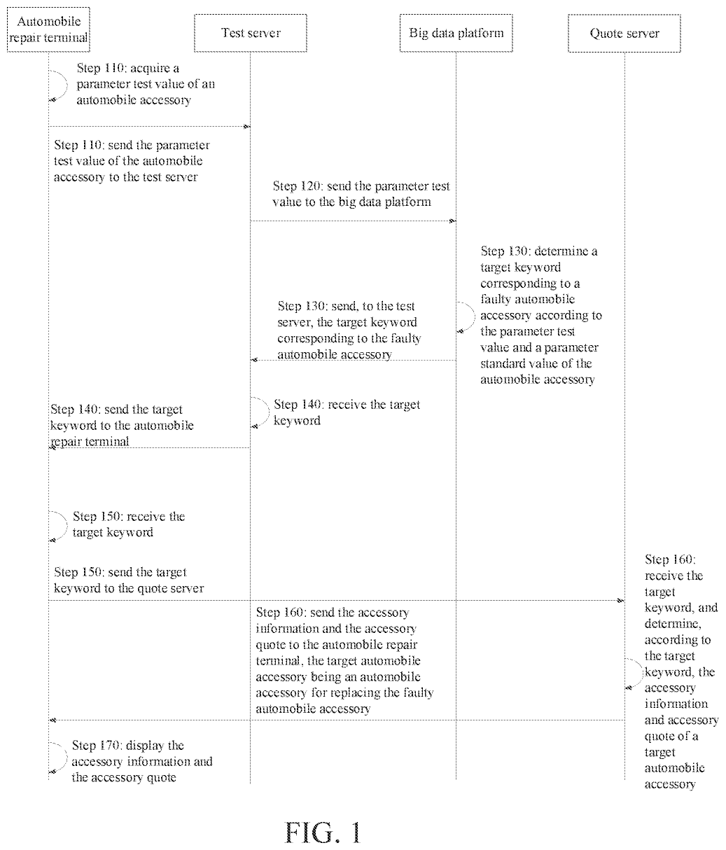

FIG. 1 shows a flow diagram of a quote display method for a faulty automobile accessory provided by an embodiment of the present invention. The method is applied to a quote display system of a faulty automobile accessory. The quote display system for a faulty automobile accessory comprises an automobile repair terminal for interacting with a user and displaying data, a test server for sending a parameter test value, a big data platform for determining a faulty automobile accessory, and a quote server for determining accessory information and accessory quote.

As shown in FIG. 1, the method comprises steps as follows.

Step 110: an automobile repair terminal acquires a parameter test value of an automobile accessory, and sends the parameter test value of the automobile accessory to a test server.

The automobile repair terminal is a terminal device for providing automobile repair services, comprising a tablet device, a desktop computing device, etc. The parameter test value of an automobile accessory is obtained by an automobile repairman testing the automobile accessory through an automobile repair test device, and the parameter test value may comprise a fault code, a fault phenomenon, a fault cause, etc. The parameter test value of an automobile accessory is used to indicate the actual running state of an automobile accessory. Automobile accessories refer to the components that make up an automobile. Automobile accessories may include the components that are configured when the automobile leaves the factory, the components that are newly configured after the automobile leaves the factory or the accessories that replace the originally configured components after the automobile leaves the factory. Automobile accessories include physical accessories and electronic accessories. Electronic accessories refer to the accessories that can generate or transmit an electrical signal in the automobile, and physical accessories refer to accessories other than electronic accessories in the automobile. An automobile repairman may input a parameter test value of an automobile accessory to an automobile repair terminal, or the automobile repair terminal communicates with the vehicle to directly obtain the parameter test value, so that the automobile repair terminal acquires the parameter test value of the automobile accessory. The test server is generally a server. The automobile repair terminal is connected to the test server via a network so that the parameter test value of the automobile accessory can be sent to the test server.

Step 120: the test server sends the parameter test value to the big data platform.

The automobile accessory generally comprises multiple parameters, and each parameter comprises one or more parameter test values. The test server can receive the parameter test value of the automobile accessory sent by the automobile repair terminal, and send the parameter test value of the automobile accessory to the big data platform. The parameter test value of the automobile accessory may include the parameter test value of various automobile accessories in the whole vehicle, or the parameter test value for a specific automobile accessory.

Step 130: the big data platform determines a target keyword corresponding to a faulty automobile accessory according to the parameter test value and a parameter standard value of the automobile accessory, and sends the target keyword corresponding to the faulty automobile accessory to the test server.

A parameter standard value of an automobile accessory is stored on a big data platform, and the parameter standard value of the automobile accessory is used for indicating a standard running state of the automobile accessory. The big data platform can receive a parameter test value sent by a test server, query a parameter standard value corresponding to the parameter test value, and compare the parameter test value with the parameter standard value. If the parameter test value is within the range of the parameter standard value, the corresponding automobile accessory is determined as a non-fault automobile accessory; if the parameter test value is outside the range of the parameter standard value, the corresponding automobile accessory is determined as a faulty automobile accessory. Therefore, according to the comparison result between the parameter test value of the automobile accessory and the parameter standard value of the automobile accessory, whether the automobile accessory is a faulty automobile accessory can be determined, and the target keyword corresponding to the faulty automobile accessory can be further determined. A faulty automobile accessory is an automobile accessory that may need replacement, including a slightly faulty automobile accessory and a severely faulty automobile accessory.

In an alternative mode, each automobile accessory corresponds to multiple parameter test values. The big data platform determines a parameter standard value corresponding to each of the multiple parameter test values according to multiple parameter test values of the automobile accessory; if a difference value between any parameter test value and a corresponding parameter standard value is outside a preset threshold range, an automobile accessory corresponding to the parameter test value is determined to be a faulty automobile accessory, and a keyword corresponding to the faulty automobile accessory is determined to be a target keyword.

The target keyword is used for identifying a faulty automobile accessory, and the big data platform can send the target keyword corresponding to the faulty automobile accessory to the test server.

The target keyword corresponding to the faulty automobile accessory comprises at least one of the following information:

the model of the faulty automobile accessory, the name of the faulty automobile accessory, the information such as the vehicle type, vehicle model, and year of the automobile to which the faulty automobile accessory belongs, a specific faulty component of the faulty automobile accessory, and the picture or shape information of the faulty automobile accessory, etc.

In an alternative mode, the big data platform pre-stores a first correspondence of an automobile accessory and a corresponding keyword. After the big data platform determines the faulty automobile accessory in the automobile accessories according to the parameter test value of the automobile accessories and the parameter standard value of the automobile accessories, the target keyword can be determined according to the faulty automobile accessory and the first correspondence. It needs to be noted that a big data platform may be used to simultaneously determine whether multiple automobile accessories are faulty automobile accessories. If the big data platform determines multiple faulty automobile accessories, a target keyword of each faulty automobile accessory can be respectively determined according to the first correspondence so as to send the multiple target keywords to the test server. If the big data platform determines one faulty automobile accessory, the target keyword of the faulty automobile accessory can be determined according to the first correspondence so as to send the target keyword to the test server.

In another alternative mode, the big data platform may determine the target keyword corresponding to a faulty automobile accessory based on a keyword extraction algorithm. According to the keyword extraction algorithm, the target keyword for describing the characteristics of the faulty automobile accessory can be extracted from the relevant information about the faulty automobile accessory. Target keywords can be specifically referred to the above description.

In yet another alternative mode, the big data platform may combine the two modes described above to determine the target keyword. For example, a big data platform determines a comprehensive target keyword according to target keywords respectively corresponding to multiple faulty automobile accessories. Alternatively, the big data platform determines a comprehensive target keyword according to multiple faulty automobile accessories and a keyword extraction algorithm, and the comprehensive target keyword covers common features of multiple faulty automobile accessories. For example, if the damage of multiple faulty automobile accessories requires replacing the system in which multiple faulty automobile accessories are located, the determined comprehensive target keyword is the target keyword corresponding to the system in which the multiple faulty automobile accessories are located.

Step 140: the test server receives the target keyword, and sends the target keyword to the automobile repair terminal.

After receiving the target keyword, the test server further sends the target keyword to the automobile repair terminal so that the automobile repair terminal acquires the target keyword.

In an alternative mode, after receiving the target keyword, the automobile repair terminal may display the target keyword to a user, and the user may perform correction, editing, supplement, and like operations on the target keyword so as to obtain a more accurate target keyword.

Step 150: the automobile repair terminal receives the target keyword, and sends the target keyword to a quote server.

After receiving the target keyword, the automobile repair terminal sends the target keyword to the quote server so as to request quote information about the automobile accessory which can replace the faulty automobile accessory from the quote server.

In an alternative mode, the automobile repair terminal communicates with the quote server via the HTTP protocol (HyperText Transfer Protocol). The accessory inquiry and quote interface of the quote server is used for receiving the target keyword sent by the automobile repair terminal. The automobile repair terminal imports the target keyword into a parameter of the accessory inquiry and quote interface of the quote server through the HTTP protocol, so that the quote server acquires the target keyword.

In another alternative mode, the automobile repair terminal communicates with the quote server through a message queue. The automobile repair terminal imports the target keyword into a parameter of the accessory inquiry and quote interface of the quote server through the message queue, so that the quote server acquires the target keyword.

Step 160: the quote server receives the target keyword, determines, according to the target keyword, the accessory information and accessory quote of a target automobile accessory, and sends the accessory information and the accessory quote to the automobile repair terminal, the target automobile accessory being an automobile accessory for replacing the faulty automobile accessory.

The quote server is generally a server. After receiving the target keyword, the quote server may determine the accessory information and the accessory quote of the target automobile accessory according to the target keyword and the network search algorithm, and send the accessory information and the accessory quote to the automobile repair terminal. The target automobile accessory is an automobile accessory for replacing a faulty automobile accessory, and the target automobile accessory may include an automobile accessory identical to the faulty automobile accessory or an automobile accessory not identical to the faulty automobile accessory, that is, the target automobile accessory may realize complete replacement or partial replacement of the faulty automobile accessory. The same faulty automobile accessory generally corresponds to a target automobile accessory manufactured by multiple different manufacturers. Target automobile accessories manufactured by different manufacturers can be used to replace a faulty automobile accessory, and have different quotes. Accessory information and accessory quotes typically include accessory information and accessory quotes for multiple target automobile accessories.

In an alternative mode, the quote server pre-stores a keyword and the second correspondence of the corresponding accessory information and accessory quote. The quote server determines the accessory information about and the accessory quote of the target automobile accessory according to the target keyword and the second correspondence. According to the target keyword and the second correspondence, the quote server can uniquely determine the accessory information about and the accessory quote of the target automobile accessory. For example, the target keyword is “tire, model 225/65R17”, and the accessory information and accessory quote corresponding to the target keyword is “tire, distributor A, model 225/65R17, 2500 RMB”. According to the target keyword and the second correspondence, the quote server may also determine the accessory information about and the accessory quote of multiple target automobile accessories. For example, the target keyword is “tire, model 225/65R17”, and the accessory information and accessory quote corresponding to the target keyword are “tire, distributor A, model 225/65R17, 2500 RMB”, “tire, distributor B, model 225/65R17, 2700 RMB”, and “tire, distributor C, model 225/65R17, 2000 RMB”, respectively.

Step 170: the automobile repair terminal displays the accessory information and the accessory quote.

The automobile repair terminal may receive the accessory information and the accessory quote sent by the quote server, and display the accessory information and the accessory quote, so that the automobile repairman formulates a maintenance scheme according to the accessory information and the accessory quote. Further, the automobile repair terminal may prioritize multiple target automobile accessories according to the accessory information and the accessory quote, and selection conditions input by the automobile repair personnel, historical maintenance information, etc. so as to facilitate the selection by automobile repairman at the time of displaying. For example, the automobile repair terminal may prioritize multiple target automobile accessories according to the market price, so that the target automobile accessories with a lower market price are ranked at the front and the target automobile accessories with a higher market price are ranked at the rear. Therefore, the maintenance personnel can quickly determine the target automobile accessories with a low cost and formulate a maintenance scheme according to the determined target automobile accessories.

The embodiment of the present invention acquires a parameter test value of an automobile accessory via an automobile repair terminal, a test server sends the parameter test value to a big data platform, and the big data platform determines a target keyword according to the parameter test value and a parameter standard value; the test server sends the target keyword to an automobile repair terminal; the automobile repair terminal sends the target keyword to the quote server; the quote server determines the accessory information and the accessory quote of a target automobile accessory according to the target keyword, and sends the accessory information and the accessory quote to the automobile repair terminal, so that the automobile repair terminal displays the accessory information and the accessory quote. Through the above-mentioned steps, after the parameter test value of an automobile accessory is acquired by an automobile repair terminal, the faulty automobile accessory can be automatically determined, and the accessory information and accessory quote of the target automobile accessory can be displayed, which is conducive to enabling automobile repairman to quickly look for an accessory quote and quickly generate a maintenance scheme.

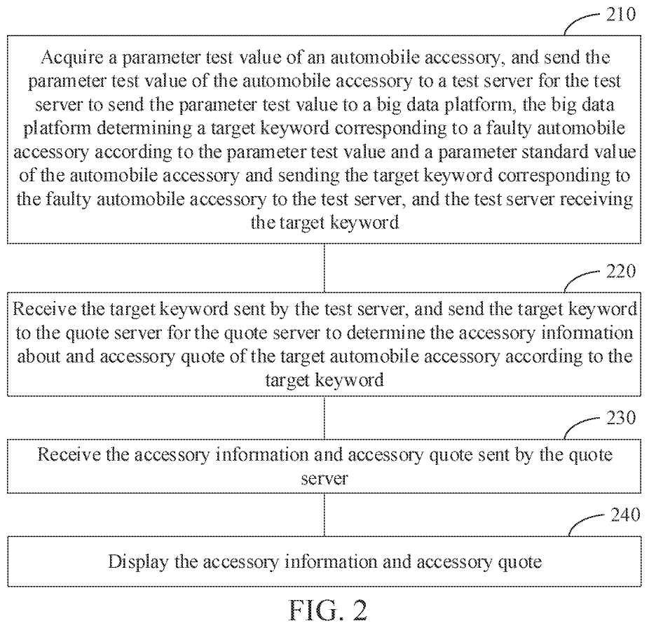

FIG. 2 shows a flow diagram of a quote display method for a faulty automobile accessory provided by another embodiment of the present invention. The method is applied to an automobile repair terminal of a quote display system of a faulty automobile accessory. The quote display system for a faulty automobile accessory comprises an automobile repair terminal for interacting with a user and displaying data, a test server for sending a parameter test value, a big data platform for determining a faulty automobile accessory, and a quote server for determining accessory information and accessory quote.

As shown in FIG. 2, the method comprises steps as follows.

Step 210: acquire a parameter test value of an automobile accessory, and send the parameter test value of the automobile accessory to a test server for the test server to send the parameter test value to a big data platform, the big data platform determining a target keyword corresponding to a faulty automobile accessory according to the parameter test value and a parameter standard value of the automobile accessory and sending the target keyword corresponding to the faulty automobile accessory to the test server, and the test server receiving the target keyword.

The parameter test value of the automobile accessory is obtained by an automobile repairman testing the automobile accessory through an automobile repair test device. The parameter test value of an automobile accessory is used to indicate the actual running state of an automobile accessory. After the automobile repair terminal acquires the parameter test value of the automobile accessory, the parameter test value of the automobile accessory is further sent to the test server. The test server can send a parameter test value to a big data platform. The big data platform can receive a parameter test value of the automobile accessory, acquire a parameter standard value of the automobile accessory, determine a target keyword corresponding to the faulty automobile accessory according to the parameter test value of the automobile accessory and the parameter standard value of the automobile accessory, and send the target keyword corresponding to the faulty automobile accessory to the test server. The parameter standard value of the automobile accessory is used to indicate the standard running state of the automobile accessory. The test server receives the target keyword, and sends the target keyword to the automobile repair terminal.

Step 220: receive the target keyword sent by the test server, and send the target keyword to the quote server for the quote server to determine the accessory information about and accessory quote of the target automobile accessory according to the target keyword.

The automobile repair terminal receives the target keyword sent by the test server, and sends the target keyword to the quote server, so that the quote server determines the accessory information about and the accessory quote of the target automobile accessory according to the target keyword.

In an alternative mode, the automobile repair terminal communicates with the quote server through an HTTP protocol, and the automobile repair terminal sends the target keyword to the quote server through the HTTP protocol.

In another alternative mode, the automobile repair terminal communicates with the quote server through a message queue, and the automobile repair terminal sends the target keyword to the quote server through the message queue.

Step 230: receive the accessory information and accessory quote sent by the quote server.

The automobile repair terminal receives the accessory information and the accessory quote sent by the quote server.

Step 240: display the accessory information and accessory quote.

The automobile repair terminal displays the accessory information and accessory quote of the target automobile accessory, so that the automobile repairman can designate a maintenance scheme according to the accessory information and accessory quote of the target automobile accessory.

The embodiment of the present invention acquires a parameter test value of an automobile accessory via an automobile repair terminal, a test server sends the parameter test value to a big data platform, and the big data platform determines a target keyword according to the parameter test value and a parameter standard value; the test server sends the target keyword to an automobile repair terminal; the automobile repair terminal sends the target keyword to the quote server; the quote server determines the accessory information and the accessory quote of a target automobile accessory according to the target keyword, and sends the accessory information and the accessory quote to the automobile repair terminal, so that the automobile repair terminal displays the accessory information and the accessory quote. Through the above-mentioned steps, after the parameter test value of an automobile accessory is acquired by an automobile repair terminal, the faulty automobile accessory can be automatically determined, and the accessory information and accessory quote of the target automobile accessory can be displayed, which is conducive to enabling automobile repairman to quickly look for an accessory quote and quickly generate a maintenance scheme.

FIG. 1 shows a schematic structural diagram of a quote display apparatus for a faulty automobile accessory according to an embodiment of the present invention. The apparatus is applied to an automobile repair terminal of a quote display system of a faulty automobile accessory. The quote display system for a faulty automobile accessory comprises an automobile repair terminal for interacting with a user and displaying data, a test server for sending a parameter test value, a big data platform for determining a faulty automobile accessory, and a quote server for determining accessory information and accessory quote.

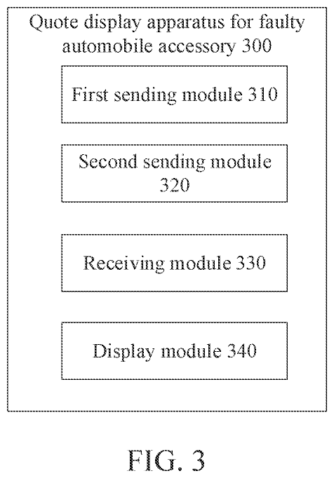

As shown in FIG. 3, the apparatus 300 includes a first sending module 310, a second sending module 320, a receiving module 330, and a display module 340.

The first sending module 310 is configured to acquire a parameter test value of an automobile accessory, and send the parameter test value of the automobile accessory to a test server for the test server to send the parameter test value to a big data platform, the big data platform determining a target keyword corresponding to a faulty automobile accessory according to the parameter test value and a parameter standard value of the automobile accessory and sending the target keyword corresponding to the faulty automobile accessory to the test server, and the test server receiving the target keyword.

The second sending module 320 is configured to receive the target keyword sent by the test server, and send the target keyword to the quote server for the quote server to determine the accessory information about and accessory quote of the target automobile accessory according to the target keyword.

The receiving module 330 is configured to receive the accessory information and accessory quote sent by the quote server.

The display module 340 is configured to display the accessory information and accessory quote.

In an alternative mode, the automobile repair terminal communicates with the quote server through an HTTP protocol. The second sending module 320 is configured to:
send the target keyword to the quote server through the HTTP protocol.

In an alternative mode, the automobile repair terminal communicates with the quote server via a message queue, and the second sending module 320 is configured to:
send the target keyword to the quote server via the message queue.

According to the embodiment of the present invention, the first sending module acquires a parameter test value of an automobile accessory, and sends the parameter test value to the test server, so that the test server sends the parameter test value to the big data platform, and the big data platform determines the target keyword according to the parameter test value and the parameter standard value; the second sending module receives the target keyword sent by the test server and sends the target keyword to the quote server; the receiving module receives the accessory information and the accessory quote sent by the quote server, and the display module displays the accessory information and the accessory quote. Through the above-mentioned steps, after the parameter test value of an automobile accessory is acquired by an automobile repair terminal, the faulty automobile accessory can be automatically determined, and the accessory information and accessory quote of the target automobile accessory can be displayed, which is conducive to enabling automobile repairman to quickly look for an accessory quote and quickly generate a maintenance scheme.

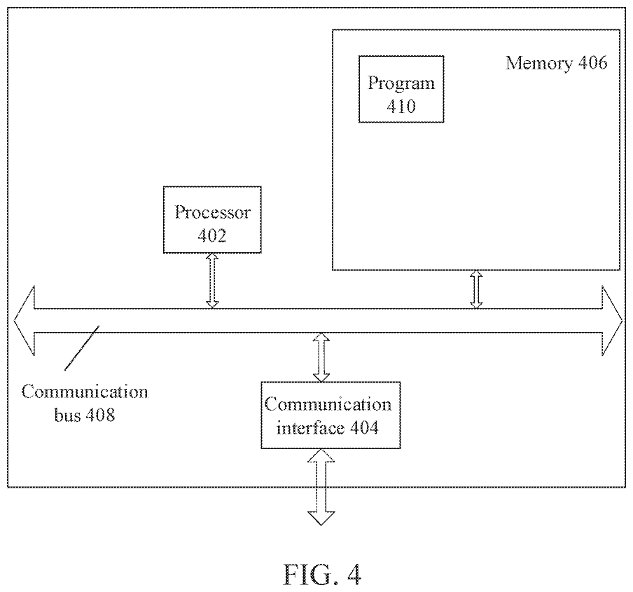

FIG. 4 shows a schematic structural diagram of an electronic device according to an embodiment of the present invention. The electronic device is used as an automobile repair terminal for a quote display system of a faulty automobile accessory. The quote display system for a faulty automobile accessory comprises an automobile repair terminal for interacting with a user and displaying data, a test server for sending a parameter test value, a big data platform for determining a faulty automobile accessory, and a quote server for determining accessory information and accessory quote.

A specific embodiment of the present invention does not limit the specific implementation of the electronic device.

As shown in FIG. 4, the electronic device may include a processor 402, a communications interface 404, a memory 406, and a communication bus 408.

The processor 402, the communication interface 404, and the memory 406 complete mutual communication through the communication bus 408. The communication interface 404 is used for communicating with a network element of other devices, such as a client, or other servers. The processor 402 is used to execute a program 410, and specifically the relevant steps in the above embodiment of a quote display method for a faulty automobile accessory can be executed.

In particular, the program 410 may include a program code comprising a computer-executable instruction.

The processor 402 may be a central processing unit CPU, or an application-specific integrated circuit ASIC, or one or more integrated circuits configured to implement an embodiment of the present invention. The electronic device comprises one or more processors, which may be the same type of processor, such as one or more CPUs; or may also be processors of different types, such as one or more CPUs and one or more ASICs.

The memory 406 is used for storing a program 410. The memory 406 may include a high-speed RAM memory, or may also include non-volatile memory, such as at least one disk memory.

The program 410 may be specifically called by the processor 402 to cause the electronic device to execute the following operations:
acquiring a parameter test value of an automobile accessory, and sending the parameter test value of the automobile accessory to a test server for the test server to send the parameter test value to a big data platform, the big data platform determining a target keyword corresponding to a faulty automobile accessory according to the parameter test value and a parameter standard value of the automobile accessory and sending the target keyword corresponding to the faulty automobile accessory to the test server, and the test server receiving the target keyword;
receiving the target keyword sent by the test server, and sending the target keyword to the quote server for the quote server to determine the accessory information about and accessory quote of the target automobile accessory according to the target keyword;
receiving the accessory information and accessory quote sent by the quote server;
and displaying the accessory information and accessory quote.

In an alternative mode, the automobile repair terminal communicates with the quote server via an HTTP protocol, and the program 410 can be specifically called by the processor 402 to cause the electronic device to execute the following operation:
sending the target keyword to the quote server through the HTTP protocol.

In an alternative mode, the automobile repair terminal communicates with the quote server via a message queue, and the program 410 can be specifically called by the processor 402 to cause the electronic device to execute the following operation:
sending the target keyword to the quote server via the message queue.

According to the embodiment of the present invention, the electronic device acquires a parameter test value of an automobile accessory, and sends the parameter test value to the test server, so that the test server sends the parameter test value to the big data platform, and the big data platform determines the target keyword according to the parameter test value and the parameter standard value; receives the target keyword sent by the test server and sends the target keyword to the quote server; and receives the accessory information and the accessory quote sent by the quote server, and displays the accessory information and the accessory quote. Through the above-mentioned steps, after the parameter test value of an automobile accessory is acquired, the faulty automobile accessory can be automatically determined, and the accessory information and accessory quote of the target automobile accessory can be displayed, which is conducive to enabling automobile repairman to quickly look for an accessory quote and quickly generate a maintenance scheme.

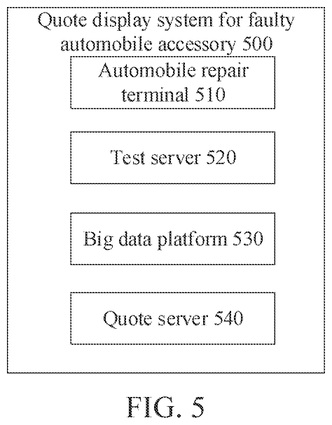

FIG. 5 shows a schematic structural diagram of a quote display system for a faulty automobile accessory according to an embodiment of the present invention. As shown in FIG. 5, the system 500 includes: an automobile repair terminal 510 for interacting with a user and displaying data, a test server 520 for sending a parameter test value, a big data platform 530 for determining a faulty automobile accessory, and a quote server 540 for determining accessory information and accessory quote 540.

The automobile repair terminal 510 is used for acquiring a parameter test value of an automobile accessory, and sending the parameter test value of the automobile accessory to the test server 520.

The test server 520 is used for sending the parameter test value to the big data platform 530.

The big data platform 530 is used for determining a target keyword corresponding to a faulty automobile accessory according to the parameter test value and a parameter standard value of the automobile accessory, and sending the target keyword corresponding to the faulty automobile accessory to the test server 520.

The test server 520 is also used for receiving the target keyword and sending the target keyword to the automobile repair terminal 510.

The automobile repair terminal 510 is further configured to receive the target keyword and send the target keyword to the bidding server 540.

The quote server 540 is used for receiving the target keyword, determining accessory information about a target automobile accessory and an accessory quote according to the target keyword, and sending the accessory information and the accessory quote to the automobile repair terminal 510, the target automobile accessory being an automobile accessory for replacing the faulty automobile accessory.

The automobile repair terminal 510 is further configured to display the accessory information and the accessory quote.

The embodiment of the present invention acquires a parameter test value of an automobile accessory via an automobile repair terminal, a test server sends the parameter test value to a big data platform, and the big data platform determines a target keyword according to the parameter test value and a parameter standard value; the test server sends the target keyword to an automobile repair terminal; the automobile repair terminal sends the target keyword to the quote server; the quote server determines the accessory information and the accessory quote of a target automobile accessory according to the target keyword, and sends the accessory information and the accessory quote to the automobile repair terminal, so that the automobile repair terminal displays the accessory information and the accessory quote. Through the above-mentioned steps, after the parameter test value of an automobile accessory is acquired by an automobile repair terminal, the faulty automobile accessory can be automatically determined, and the accessory information and accessory quote of the target automobile accessory can be displayed, which is conducive to enabling automobile repairman to quickly look for an accessory quote and quickly generate a maintenance scheme.

An embodiment of the present invention provides a computer-readable storage medium storing thereon at least one executable instruction. The executable instruction, when running on electronic equipment, causes the electronic device to execute the quote display method for a faulty automobile accessory in any of the above method embodiments.

An embodiment of the present invention provides a quote display apparatus for a faulty automobile accessory, which is used to execute the quote display method for a faulty automobile accessory.

An embodiment of the present invention provides a computer program that can be called by a processor to cause electronic equipment to execute the quote display method for a faulty automobile accessory in any of the above method embodiments.

An embodiment of the disclosure provides a computer program product including a computer program stored on a computer-readable storage medium. The computer program includes program instructions which, when running on a computer, cause the computer to execute the quote display method for a faulty automobile accessory of any of the method embodiments described above.

The algorithm or display provided herein is not inherently related to any particular computer, virtual system, or other devices. Various general-purpose systems may also be used with the teachings based on what is disclosed herein. According to the above description, the structure required to construct such a system is obvious. Furthermore, embodiments of the present invention are not directed to any particular programming language. It should be understood that the contents of the invention described herein can be realized by using various programming languages, and the description of the specific language is to disclose the best implementation mode of the invention.

In the description provided herein, numerous specific details are set forth. However, it could be understood that embodiments of the invention may be practiced without these specific details. In some instances, well-known methods, structures, and techniques have not been shown in detail in order not to obscure the understanding of this description.

Similarly, it should be understood that in the above description of example embodiments of the invention, various features of the embodiments of the invention are sometimes grouped together in a single embodiment, figure, or the description thereof for the purpose of streamlining the invention and aiding in the understanding of one or more of the various inventive aspects. However, the disclosed method should not be interpreted as reflecting the intention that the claimed invention requires more features than those clearly recorded in each claim.

It could be understood by those skilled in the art that the modules in the devices in the embodiments may be changed adaptively and arranged in one or more devices different from the embodiment. Modules or units or assemblies in an embodiment may be combined into one module or unit or assembly and may be divided into multiple sub-modules or sub-units or sub-assemblies. Except that at least some of such features and/or processes or units are mutually exclusive, all features disclosed in the description (including accompanying claims, abstract, and drawings) and all processes or units of any method or device so disclosed can be combined in any combination. Each feature disclosed in the description (including any accompanying claims, abstract, and drawings) may be replaced by alternative features serving the same, equivalent, or similar purpose, unless expressly stated otherwise.

It should be noted that the above-mentioned embodiments illustrate rather than limit the invention, and that those skilled in the art can design alternative embodiments without departing from the scope of the appended claims. In the claims, any reference sign placed in a bracket shall not be construed as limiting the claims. The word “comprising” does not exclude the presence of an element or a step other than those listed in a claim. The word “a” or “one” preceding an element does not exclude the presence of multiple such elements. The present invention can be implemented by means of hardware comprising several distinct elements, and by means of a suitably programmed computer. In a unit claim enumerating several devices, several devices of these devices can be specifically embodied by one and the same item of hardware. The use of the words first, second, third, etc. does not denote any order. These words may be interpreted as names. The steps in the above embodiments are not to be construed as limiting the order of execution unless otherwise specified.

1. A quote display method for a faulty automobile accessory, being applied to a quote display system for a faulty automobile accessory, wherein the quote display system for a faulty automobile accessory comprises an automobile repair terminal for interacting with a user and displaying data, a test server for sending a parameter test value, a big data platform for determining a faulty automobile accessory, and a quote server for determining accessory information and accessory quote; the method comprising:
the automobile repair terminal acquiring a parameter test value of an automobile accessory, and sending the parameter test value of the automobile accessory to the test server;
the test server sending the parameter test value to the big data platform;
the big data platform determining a target keyword corresponding to a faulty automobile accessory according to the parameter test value and a parameter standard value of the automobile accessory, and sending the target keyword corresponding to the faulty automobile accessory to the test server;
the test server receiving the target keyword, and sending the target keyword to the automobile repair terminal;
the automobile repair terminal receiving the target keyword, and sending the target keyword to the quote server;
the quote server receiving the target keyword, determining, according to the target keyword, accessory information and accessory quote of a target automobile accessory, and sending the accessory information and the accessory quote to the automobile repair terminal, the target automobile accessory being an automobile accessory for replacing the faulty automobile accessory; and
the automobile repair terminal displaying the accessory information and the accessory quote.

2. The quote display method according to claim 1, wherein the big data platform pre-stores a first correspondence between the automobile accessory and a corresponding keyword;
the big data platform determining a target keyword corresponding to a faulty automobile accessory according to the parameter test value and a parameter standard value of the automobile accessory comprises:
the big data platform determining a faulty automobile accessory according to the parameter test value and the parameter standard value of the automobile accessory; and
the big data platform determining the target keyword according to the faulty automobile accessory and the first correspondence.

3. The quote display method according to claim 1, wherein the quote server pre-stores a keyword and a second correspondence between corresponding accessory information and accessory quote;
the quote server receiving the target keyword, and determining, according to the target keyword, accessory information and accessory quote of a target automobile accessory comprises:
the quote server receiving the target keyword, and determining accessory information about and accessory quote of the target automobile accessory according to the target keyword and the second correspondence.

4. The quote display method according to claim 1, wherein
the automobile repair terminal communicates with the quote server via an HTTP protocol;
the automobile repair terminal receiving the target keyword, and sending the target keyword to the quote server comprises:
the automobile repair terminal receiving the target keyword, and importing the target keyword into a parameter of an accessory inquiry and quote interface of the quote server via the HTTP protocol.

5. The quote display method according to claim 1, wherein
the automobile repair terminal communicates with the quote server via a message queue;
the automobile repair terminal receiving the target keyword, and sending the target keyword to the quote server comprises:
the automobile repair terminal receiving the target keyword, and importing the target keyword into a parameter of an accessory inquiry and quote interface of the quote server via a message queue.

6. The method according to claim 1, wherein the big data platform determining a target keyword corresponding to a faulty automobile accessory according to the parameter test value and a parameter standard value of the automobile accessory comprises:
the big data platform determining a parameter standard value corresponding to each parameter test value in multiple parameter test values according to the multiple parameter test values of the automobile accessory; and
if a difference value between any parameter test value and a corresponding parameter standard value is outside a preset threshold range, then the automobile accessory being determined as the faulty automobile accessory and a keyword corresponding to the automobile accessory being determined as the target keyword.

7. A quote display method for a faulty automobile accessory, being applied to an automobile repair terminal for a quote display system of a faulty automobile accessory, wherein the quote display system for a faulty automobile accessory comprises an automobile repair terminal for interacting with a user and displaying data, a test server for sending a parameter test value, a big data platform for determining a faulty automobile accessory, and a quote server for determining accessory information and accessory quote; the method comprising:
acquiring the parameter test value of an automobile accessory, and sending the parameter test value of the automobile accessory to the test server for the test server to send the parameter test value to the big data platform, the big data platform determining a target keyword corresponding to a faulty automobile accessory according to the parameter test value and a parameter standard value of the automobile accessory and sending the target keyword corresponding to the faulty automobile accessory to the test server, and the test server receiving the target keyword;
receiving the target keyword sent by the test server, and sending the target keyword to the quote server for the quote server to determine the accessory information about and the accessory quote of the target automobile accessory according to the target keyword;
receiving the accessory information and accessory quote sent by the quote server;
and displaying the accessory information and accessory quote.

8. The quote display method according to claim 7, wherein
the automobile repair terminal communicates with the quote server via an HTTP protocol;
the sending the target keyword to the quote server comprises:
sending the target keyword to the quote server through the HTTP protocol.

9. The quote display method according to claim 7, wherein
the automobile repair terminal communicates with the quote server via a message queue;
the sending the target keyword to the quote server comprises:
sending the target keyword to the quote server via the message queue.

10. (canceled)

11. An electronic device, comprising: a processor, a memory, a communication interface, and a communication bus, wherein the processor, the memory, and the communication interface complete mutual communication through the communication bus;
the memory is used for storing at least one executable instruction that causes the processor perform the following method:
acquiring a parameter test value of an automobile accessory, and sending the parameter test value of the automobile accessory to a test server for the test server to send the parameter test value to a big data platform, the big data platform determining a target keyword corresponding to a faulty automobile accessory according to the parameter test value and a parameter standard value of the automobile accessory and sending the target keyword corresponding to the faulty automobile accessory to the test server, and the test server receiving the target keyword;
receiving the target keyword sent by the test server, and sending the target keyword to a quote server for the quote server to determine the accessory information about and the accessory quote of the target automobile accessory according to the target keyword;
receiving the accessory information and accessory quote sent by the quote server; and
displaying the accessory information and accessory quote.

12. A computer-readable storage medium, wherein at least one executable instruction is stored in the storage medium, and when the executable instruction runs on an electronic device, the executable instruction causes the electronic device to execute an operation of the quote display method for a faulty automobile accessory according to claim 7.

13. (canceled)

14. The electronic device according to claim 11, wherein
the automobile repair terminal communicates with the quote server via an HTTP protocol;
the sending the target keyword to the quote server comprises:
sending the target keyword to the quote server through the HTTP protocol.

15. The electronic device according to claim 11, wherein
the automobile repair terminal communicates with the quote server via a message queue;
the sending the target keyword to the quote server comprises:
sending the target keyword to the quote server via the message queue.
